(19) United States
(12) Patent Application Publication
(10) Pub. No.: US 2026/0180376 A1
(43) Pub. Date: Jun. 25, 2026

(54) LAMINATED CORE MANUFACTURING APPARATUS AND LAMINATED CORE MANUFACTURING METHOD

(71) Applicant: POSCO MOBILITY SOLUTION CORPORATION, Cheonan-si, Chungcheongnam-do (KR)

(72) Inventors: Suk Jo KANG, Asan-si, Chungcheongnam-do (KR); Duk Kyoun WOO, Cheonan-si, Chungcheongnam-do (KR); Jung Gyu CHI, Cheonan-si, Chungcheongnam-do (KR); I Gyeong HONG, Bucheon-si, Gyeonggi-do (KR); Jeong Il LEE, Asan-si, Chungcheongnam-do (KR); Ye Eun KIM, Cheonan-si, Chungcheongnam-do (KR); Ya Gob LEE, Cheonan-si, Chungcheongnam-do (KR); Dae Yong CHOI, Cheonan-si, Chungcheongnam-do (KR); Young Seok LEE, Cheonan-si, Chungcheongnam-do (KR); Hwi Gyeoung AN, Cheonan-si, Chungcheongnam-do (KR); Ki Taek NAM, Pyeongtaek-si, Gyeonggi-do (KR); Chan Jung KIM, Cheonan-si, Chungcheongnam-do (KR); Yeon Woong KIM, Cheonan-si, Chungcheongnam-do (KR); Chang Il CHOI, Cheonan-si, Chungcheongnam-do (KR); Jae Chun YOU, Cheonan-si, Chungcheongnam-do (KR); Byoung Gwan PARK, Cheonan-si, Chungcheongnam-do (KR)

(73) Assignee: POSCO MOBILITY SOLUTION CORPORATION, Cheonan-si, Chungcheongnam-do (KR)

(21) Appl. No.: 18/706,749

(22) PCT Filed: May 24, 2023
(86) PCT No.: PCT/KR2023/007072

§ 371 Date: Mar. 3, 2026

(30) Foreign Application Priority Data
Nov. 28, 2022 (KR) 10-2022-0161797

(51) Int. Cl. H02K 1/16; H02K 1/14; H02K 15/02; H02K 15/022; H02K 15/03

(52) U.S. Cl. CPC H02K 1/16; H02K 1/148; H02K 15/02; H02K 15/022; H02K 15/03; H02K 2201/09

(57) ABSTRACT

Disclosed are a laminated core manufacturing apparatus and a laminated core manufacturing method capable of manufacturing a laminated core having a straight portion and a skewed portion. The laminated core manufacturing apparatus comprises: a blanking unit for sequentially forming laminas by blanking strip material which is intermittently transferred for a manufacturing laminated core, a first processing unit which is provided at a first side of the blanking unit, for processing the strip material before blanking the strip material, and is intermittently rotatable at a predetermined angle for changing the processing position by rotational movement and processing the strip material, a second processing unit which is provided at a first side or a second side of the first processing unit and processes the strip material at a predetermined position; and a lamination die provided coaxially with the blanking unit and having a lamination space of the laminas sequentially formed by blanking of the strip material.

### TECHNICAL FIELD

The present invention relates to a laminated core manufacturing apparatus and a method therefor, and more particularly to a laminated core manufacturing apparatus and a laminated core manufacturing method for manufacturing laminated core having a straight portion that is stacked in a straight line parallel to the axis of the laminated core and a skewed portion formed in a skewed shape,

### BACKGROUND ART

A laminated core refers to a core of a laminated structure manufactured by integrating a plurality of laminar members also called laminas. For example, the laminated core refers to a core structure manufactured by stacking and integrating the plurality of laminas obtained by blanking a metal strip.

The laminated core is used as core for various devices, e.g. rotary machines such as motors, transformers, or ignition systems. And various methods for manufacturing the laminated core are known.

As a representative method of manufacturing the laminated core, when the laminas having a predetermined shape are sequentially formed and stacked by a progressive die, and then a predetermined number of sheets of the lamina are integrated into one body, a core with a laminated structure, that is, the laminated core can be manufactured.

As a method for integrating the stacked laminas, a tap fixing method using an interlock tap, a welding method using a welding, e.g., a laser welding, and a rivet fixing method, etc., are known.

Examples of the tab fixing method are disclosed in Korean Patent Publication Nos. 10-2008-0067426 and 10-2008-0067428, etc.

Recently, technologies (adhesion methods) for integrating the laminas by bonding has been developed and used. For example, inventions that apply an adhesive on the surface of a metal strip supplied to the die and blank the metal strip for manufacturing the laminated core by bonding are disclosed in Korean Patent No. 10-1566491, and Japanese Patent Laid-open Publication No. H5-304037, etc.

And inventions that manufacture the laminated core by blanking a metal strip on which the adhesive is pre-coated, are disclosed in Korean Parent No. 10-1659238, etc.

Meanwhile, in order to manage the perpendicularity and thickness deviation of the laminated core, a method (index rotation) that a lamination die having a stacking hollow of laminas rotates by a predetermined angle at predetermined timing can be used.

The lamina is formed by blanking the metal strip. The variation in thickness across the metal strip, such as widthwise thickness differences, can lead to defects in the perpendicularity of the laminated core. This may cause faulty weight balance.

In order to solve the aforementioned problems, the index rotation method (also called index lamination) is performed during stacking of the laminas. In this method, the lamination die may rotate at a predetermined angle, for example, 180 degree each time a layer of lamina is stacked, to correct the thickness deviations.

In addition, the slot of the laminated core may be parallel to the axis, but in order to improve the physical properties of the product, there is also a structure in which the slot may have a skewed shape, that is, a twisted shape. When the lamination die rotates at a fine angle for skew stacking each time stacking is performed, the slot 1 may have the skewed shape as the example shown in FIG. 1, which has the advantage of enabling continuous and smooth rotation when the motor is driven. FIG. 1 shows an example of a laminated core having a slot of a skewed shape.

In order to manage the perpendicularity and thickness deviation of the laminated core, an adhesive-type laminated core manufacturing apparatus in which the laminas rotate by a rotary lamination die is disclosed in Korean Patent Nos. 10-1990291 and 10-1990296, etc. In the apparatus for manufacturing a laminated core using the tab fixing method, an invention that implements index rotation of the laminas is disclosed in Korean Patent No. 10-0876157, etc. And the invention for a skew stacking method for rotating the laminas and forming a slot which is inclined in a diagonal direction is disclosed in Korean Patent Laid-open Publication No. 10-2015-0031950, etc.

### DISCLOSURE

### Technical Problem

An object of the present invention is to provide an apparatus and a method for manufacturing a laminated core having both a straight portion that is stacked in a straight line parallel to the axis of the laminated core and a skewed portion in a skewed shape by processing a metal strip, that is, a strip material.

### Technical Solution

An aspect of the present invention provides a laminated core manufacturing apparatus comprises a blanking unit for sequentially forming laminas by blanking strip material which is intermittently transferred for a manufacturing laminated core, a first processing unit which is provided at a first side of the blanking unit, for processing the strip material before blanking the strip material, and is intermittently rotatable at a predetermined angle for changing the processing position by rotational movement and processing the strip material, a second processing unit which is provided at a first side or a second side of the first processing unit and processes the strip material at a predetermined position; and a lamination die provided coaxially with the blanking unit and having a lamination space of the laminas sequentially formed by blanking of the strip material.

The first processing unit may include a first die which is rotatable intermittently by a predetermined angle around the rotation axis of the first processing unit and a first tool facing the first die and configured to move forward and backward for processing the strip material. The first tool is and rotatable at the same angle simultaneously with the first die

The blanking unit includes a blanking punch provided at an upper die capable of reciprocating in a direction perpendicular to the strip material, and a blanking die facing the blanking punch and provided at a lower die facing the upper die. And the first tool may move toward the first die by the upper die to process the strip material.

The first tool may be configured to be pressed by the upper die to move toward the first die. And the first tool may be supported by an elastic member restoring the first tool. The first processing unit may further include a connector for integral rotation of the first die and the first tool.

The first die may be provided on a rotatable die support, and the die support may be connected to a driving device transmitting rotation power to the die support.

And the first tool may be provided at a tool holder. The tool holder may include a tool shaft forming an axis of the first tool, and the tool shaft may be rotatably inserted in a shaft hole formed at the upper die

The first tool may include a slot punch for punching the strip material at predetermined timings to form a slot of the laminated core

Another aspect of the present invention provides a laminated core manufacturing method of a progressive type manufacturing a laminated core by blanking a strip material at predetermined timing for manufacturing the laminated core, the strip material being intermittently transferred. The method may comprise processing sequentially target areas of blanking on the strip material at a predetermined interval along the transfer direction of the strip material and changing a processing position at a predetermined angle each time the strip material is processed

### Advantageous Effects

Regardless of whether the lamination die can rotate or not, the present invention may process a metal strip by a progressive way and manufacture a laminated core having a straight portion stacked in a straight line parallel to the axis of the laminated core and a skewed portion stacked in a skewed shape. According to the present invention, manufacture and assembly process for additional parts for forming both the straight portion and the skewed portion in the laminated core can be omitted. This can facilitate the easy production of laminated cores with skewed portions.

### DESCRIPTION OF DRAWINGS

The present invention can be well appreciated with reference to drawings described below jointly with a detailed description for exemplary embodiments of the present invention to be described below, in which:

FIG. 1 is a perspective view illustrating an example of a laminated core with skewed slots;

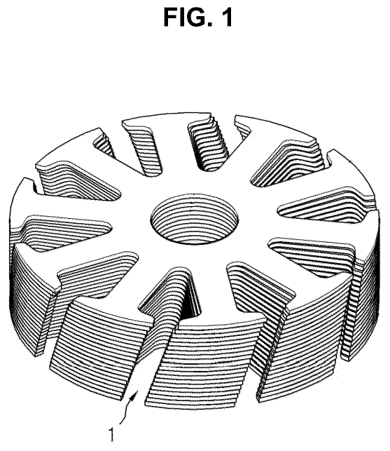

FIG. 2 is a perspective view showing an example of a laminated core that can be manufactured by an embodiment of the present invention;

FIG. 3 is a perspective view showing the laminated core shown in FIG. 2 cut in the vertical direction;

FIG. 4 is a diagram showing an embodiment of the laminated core manufacturing apparatus according to the present invention;

FIG. 5 is a plan view showing a die structure applied to a lower die of the laminated core manufacturing apparatus shown in FIG. 4;

FIG. 6 shows a first processing unit of the laminated core manufacturing apparatus shown in FIG. 4;

FIG. 7 is a widthwise cross-sectional view schematically showing the first processing unit of the laminated core manufacturing apparatus shown in FIG. 4;

FIG. 8 is a plan view of a lamina manufactured by the laminated core manufacturing apparatus shown in FIG. 4; and

FIG. 9 shows a layout of a strip material processed by the laminated core manufacturing apparatus shown in FIG. 4.

### BEST MODE

Hereinafter, preferred embodiments of the present invention are described with reference to the accompanying drawings. In describing the embodiments, the same name and the same reference numeral are used with respect to the same element and repetitive description thereto will be omitted. And the descriptions of technologies well known in the art are omitted or minimized.

The terms used herein are used to explain embodiments of the present invention, and do not limit the present invention. For example, terms regarding ordinal numbers, such as “first” and “second,” may be used to distinguish elements from each other, but do not define or limit the number of elements.

And when an element is mentioned as “connected”, “stacked”, or “provided” to other element, although it may be directly connected or stacked or provided, it should be understood that it also includes a relationship with another element therebetween, that is, a relationship of indirect connection.

In this specification, it should be understood that term “include” or “have” described in this specification not exclude a possibility of presence or addition of one or more other features, numbers, steps, operations, components, parts or combinations thereof.

Embodiments of the present invention relate to an apparatus and a method for manufacturing a laminated core formed by stacking laminas (L; also referred to as ‘core sheet’ or ‘core piece’, etc.).

The laminated core manufacturing apparatus according to an embodiment of the present invention is a progressive-type device blanking a strip material that is intermittently and continuously transferred so as to form laminas with a predetermined shape and integrating the laminas for manufacturing cores of motors, generators, transformers, etc. The laminas may be integrated by a tab fixing method using embossing-shaped protrusions (embossing protrusions), also called caulking, but integrating method of the laminas is not limited thereto. The laminas may be integrated by other methods, such as an adhesion method where the interfaces of the laminas are bonded with an adhesive.

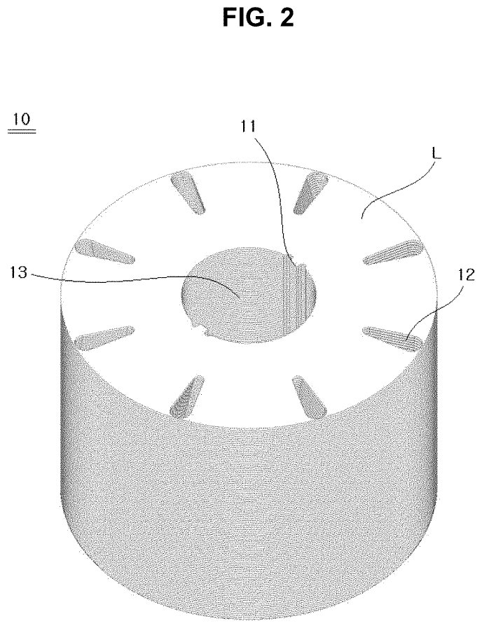

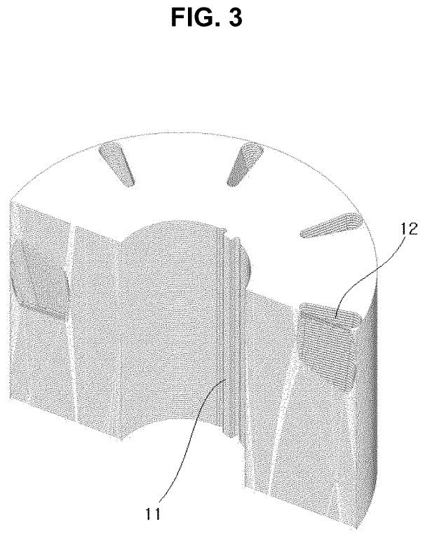

Referring to an example of the laminated core shown in FIGS. 2 and 3, the laminated core manufacturing apparatus is a progressive device which can manufacture a laminated core 10 having a straight portion 11 and a skewed portion 12.

The straight portion 11 is a part having a straight shape stacked in a straight line parallel to the axis of the laminated core, for example, a groove, protrusion, or hole, etc. The straight portion is formed in a straight line at the laminated core. And the skewed portion 12 is a part with a skewed shape, that is, a spirally twisted shape, and shapes of the straight portion and the skewed portion may vary according to the core design.

As a particular example, the straight portion 11 of this embodiment is a shaft coupling portion where the shaft of the motor is coupled, and protrudes from the inner circumference of the shaft hole 13 into which the shaft of the motor is inserted and is formed vertically along the longitudinal direction. And the skewed portion 12 may form a slot of the laminated core and penetrate the laminated core at an oblique angle.

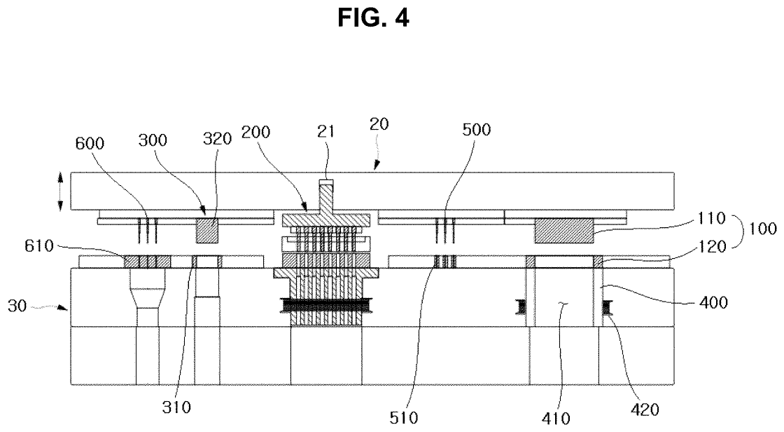

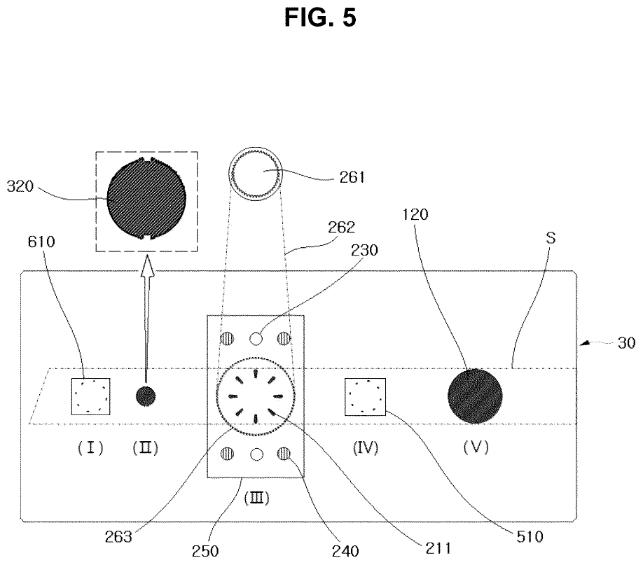

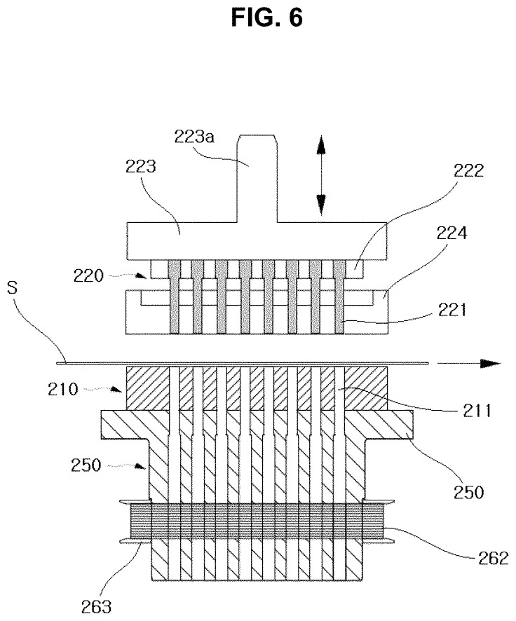

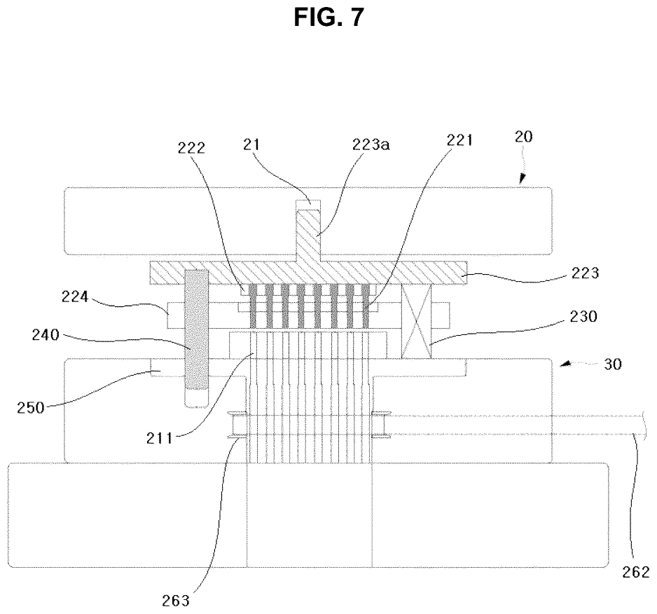

Referring to FIGS. 4 to 9, an embodiment of the laminated core manufacturing apparatus includes a blanking unit 100, a first processing unit 200, a second processing unit 300, and a lamination die 400.

More particularly, the blanking unit 100 is an element for sequentially forming laminas L by blanking strip materials for manufacturing laminated cores that are intermittently transferred.

And the first processing unit 200 is an element that processes the strip material S before blanking, is provided at a first side of the blanking unit 100, and is rotatable intermittently at a predetermined angle for changing the processing position by rotational movement and processing the strip material

That is, the first processing unit 200 is a component that forms the first structure 11a of a predetermined shape at the target areas of blanking on the strip material S before the blanking, and is provided at an upstream of the blanking unit 100 in the transfer direction of the strip material.

In this embodiment, as an example of the first processing portion 200, a device punching the strip material S to form a slot (skewed portion in this embodiment) 12 of the laminated core is described. Examples of the skewed portion are not limited to the slot, and for example, structures such as holes that penetrate the laminated core or protrusions formed at an eccentric position may also have a skew shape according to design conditions. A plurality of the first processing units 200 may be provided at the upstream of the blanking unit in the transfer direction of the strip material, and the portions punched out by the plurality of first processing units may form skewed portions, respectively.

And the second processing unit 300 is provided at one side or the other side of the first processing unit 200 and processes the strip material S at a predetermined position. That is, the second processing unit 300 is an element that forms the second structure 12a of a predetermined shape at the target area of blanking.

In this embodiment, as an example of the second processing unit 300, a device for punching the strip material S to form the shaft coupling portion 11 and shaft hole 13 is described.

The lamination die 400 and the blanking unit 100 are coaxial, and the lamination die 400 has lamination space 410 of the laminas L sequentially formed by blanking the strip material S. That is, the laminas L formed from the strip material S by blanking are sequentially introduced into the lamination die 400 and stacked inside the lamination die 400, and predetermined sheets of the lamina are integrated by the tab fixing method using embossing protrusions called the interlock tabs or the adhesion method, etc. thereby forming a laminated core.

The blanking unit 100 includes a blanking punch 110 capable of reciprocating in a direction perpendicular to the strip material S, and a blanking die 120 facing the blanking punch 110.

In this embodiment, the blanking punch 110 reciprocates in the direction perpendicular to the surface of the strip material S. For example, the blanking punch is provided at the upper die 20 capable of moving upward and downward as shown in FIG. 4 and goes up and down with the upper die 20. And the blanking die 120 is provided on the lower die 30 facing the upper die 20 at a distance, and the lamination die 400 is provided below the blanking die 120.

The first processing unit 200 may include a rotatable first die 210 and a first tool 220 facing the first die 210.

More particularly, the first die 210 can intermittently rotate at predetermined angle around the axis of the first processing unit 200. The rotation angle of the first die 210 may be determined by considering the angle of the skewed portion, etc.

The first tool 220 can configured to face the first die 210 and move forward and backward (go up and down) for processing the strip material S. The first processing unit, particularly, the first tool 220 can be configured to be a separate element provided at one side (upstream area of the upper die based on the transfer direction of the strip material) of the upper die 20 where the blanking punch is mounted. However, in this embodiment, the first tool 220 moves toward the first die 210 by the upper die 20 to process the strip material S.

In this embodiment, the first tool 220 is pressed by the upper die 20 and moves (descends) toward the first die 210 and supported toward the upper die by an elastic member 230 such as a coil spring, etc. to restore to its original position.

The first processing unit 200 is connected to a driving device and rotates step by step at a predetermined angle. For example, the driving device transmits rotation power to the first die 210, and the first tool 220 may follow the first die 210 to synchronously rotate with the first die 210.

Conversely, the driving device may transmit power to the first tool 220 and the first die 210 may follow the first tool 220. However, the first die 210 and the first tool 220 may receive power from driving devices, respectively. Therefore, the rotation mechanism of the first processing unit 200 is not limited to this embodiment. In this embodiment, the first die 210 receives power from a driving device and the first tool 220 is driven by the first die 210 to rotate.

The first processing unit 200 may further include a connector 240 for integrally rotating the first die 210 and the first tool 220. More particularly, the first die 210 and the first tool 220 may be connected by the connector such as a post, for integral rotation, the connector 240 allows the integral rotation of the first die 210 and the first tool 220 and guides the first tool 220 to move up/down.

In this embodiment, the first die 210 is provided on a rotatable die support 250. And the die support 250 may be connected to the driving device 260 which transmits the rotation power to the die support 250.

Examples of the driving device 260 include a belt 262 that transmits the rotation power of the motor 261 to the die support 250 and a pulley 263 where the belt is wound. However, Examples of the driving device are limited to above-mentioned mechanism, for example, a gear driving device is also possible.

In this embodiment, a ring-shaped pulley 263 is fixed to the outer circumference of the die support 250, and the pulley 263 transmits the rotation power of the motor 261 from the belt 262 to the die support 250. Accordingly, the first die 210 fixed to the die support 250 is rotated by the motor 261, and the connector 240 allows the first tool 220 to rotate with the first 210 die. The motor 261 may rotate in the reverse direction, and when the total rotation angle of the first die 210 reaches a preset angle, the first die 210 may be configured to be returned to the reference position (original position).

Meanwhile, although not shown in drawings, as additional example of rotation mechanism that the first tool 220 receives the power of the driving device and the first die 210 is driven by the first tool 220, a belt-pulley transmission mechanism may be applied to a tool holder.

The first tool 220 is provided at a tool holder 223, and the tool holder 223 may include a tool shaft 223a forming an axis of the first tool 220. The tool shaft 223a is rotatably inserted in the shaft hole 21 formed in the upper die 20. The shaft hole 21 may have clearance. The clearance may allow the tool shaft 223a to enter into the clearance, when the upper die 20 descends.

The first tool 220 can form the first structure 11a on the strip material S by applying an pressing force to the strip material S. In this embodiment, the first tool 220 includes a first punch 221 that punches the strip material S at predetermined timings to form the first structure 11a. The first punch 221 is fixed to the punch holder 222, and the punch holder 222 is provided at the tool holder 223. According to this embodiment, the portion formed by the first punch 221, that is, the first structure 11a, may form the skewed portion. For example, the first punch 221 may be a slot punch for punching the strip material S to form the slot of the laminated core in a skewed shape.

In this embodiment, the first tool 220 has the same number of slot punches 221 as the number of slots. And the first die 210 includes punch holes 211 facing each the slot punch 221 one to one and rotate with the slot punches 221 at the same angle.

The elastic member 230 such as a spring for restoration (lifting) of the first tool 220 supports the tool holder 223 upward, and a stripper 224 is provided between the tool holder 223 and the first die 210. Therefore, the elastic member 230 may allow a space between the first die 210 and the first tool 220 to open, and the strip material S can pass between the first die 210 and the first tool 220.

The stripper 224 presses the strip material S when the first tool 220 processes the strip material and separates the first tool 220 from the strip material S when the first tool 220 goes up. Although not shown, the apparatus may include an elastic member such as a spring for opening a space between the tool holder 223 and the stripper 224. In addition, the upper die 20 is provided with a stripper for the second processing unit and the blanking unit. Since the function and structure of the stripper itself in the progressive die are known, additional description of the stripper is omitted.

In this embodiment, the connector 240 passes through the stripper 224 and connects the tool holder 223 and the die support 250, and thus the connection and the integral rotation of the first die and the first tool can be implemented.

The second processing unit 300 includes a second die 310 provided on the lower die 30 so as to process the shaft coupling portion 11 and the shaft hole 13, and a second tool 320 coaxially provided on the axis of the second die 310. That is, in this embodiment, the second tool 320 is a punch for machining the shaft coupling portion.

In addition to the first processing unit 200 and the second processing unit 300, the apparatus according to the present embodiment may further include at least one additional processing unit for forming a predetermined structure at the strip material.

For example, for integrating the laminas L with the tab fixing method, the upper die 20 is provided with an embossing tip 500 forming an embossing protrusion E on the strip material S and a piercing punch 600 forming the piercing hole H at a predetermined timings (timings of processing the lowest layer of each the laminated core).

And the lower die 30 is provided with an embossing die 510 and a piercing die 610 corresponding to the embossing tip 500 and the piercing punch 600.

The position of the first processing unit 200, the second processing unit 300, the embossing punch 500, and the piercing punch 600 is not limited to the example shown in FIG. 4 and can vary. For example, the second processing unit 300 forming the shaft coupling portion 11 may be provided between the first processing unit 200 and the embossing punch 500.

According to the laminated core manufacturing apparatus having the above-described elements, hole punching is performed at preset timings at the piercing hole processing stage I, and shaft coupling portion/shaft hole punching is performed at the shaft coupling portion processing stage II.

At the slot forming stage III, each time the strip material S is punched, the slot punching position is shifted by rotation at a preset little angle. And at the embossing processing stage IV, embossing process is performed to integrate the laminas. At the blanking stage V, blanking process of punching out the target area of the blanking is performed, so that the laminas are integrated in the lamination die 400 using a tab fixing method and laminated cores can be manufactured.

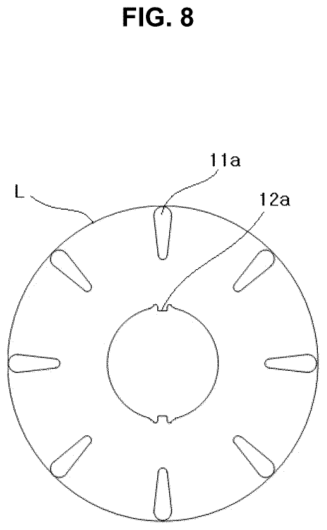

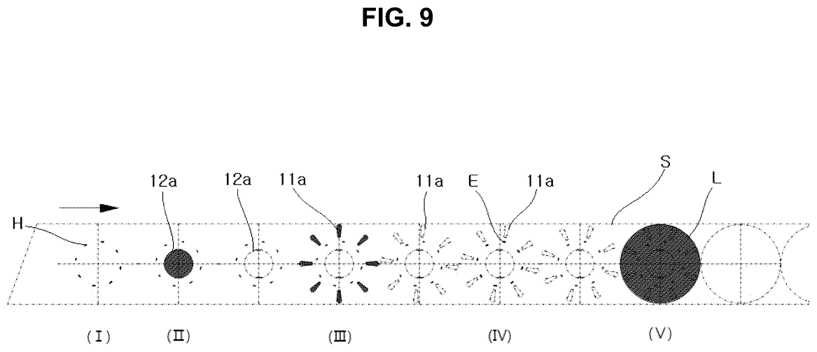

For reference, FIG. 8 shows a lamina on which the embossing protrusions are omitted, and FIG. 9 shows the layout of a strip material processed by the laminated core manufacturing apparatus above described.

In case of manufacturing an adhesive laminated core by the adhesion method bonding the laminas, an adhesive applicator for applying adhesive to the surface of the strip material is provided at the lower die and/or upper die, instead of processing units for processing the embossing protrusions and piercing holes.

The lamination die 400 may rotate at a predetermined angle at predetermined timings. For example, in order to manage the perpendicularity and thickness deviation of the laminated core, the laminated die 400 having a lamination space of laminas rotates by a predetermined angle, for example, 180° index rotation at predetermined timing, may be rotatably provided in the lower die. As a particular example, a belt-pulley for rotation of the lamination die 400 may be applied to the lamination die 400. Meanwhile, according to present embodiment, by adjusting the rotation direction and angle of the lamination die 400, the portion processed by the first processing unit 200 may form the straight portion, and the portion processed by the second processing unit 300 may form the skewed portion.

The embodiment of the present invention can provide a method of progressive type manufacturing a laminated core by blanking a strip material intermittently transferred at predetermined timings.

The laminated core manufacturing method may include a shift processing step of sequentially processing the target areas of blanking on the strip material at a predetermined interval along the transfer direction of the strip material and changing a processing position at a predetermined angle each time the strip material is processed.

In this embodiment, the shift processing step is a step for forming the skewed portion, for example, the slot of a laminated core, by punching the strip material S. And based on the transfer direction of the strip material S, at upstream or downstream of stage III where the shift processing step is performed, a punching process is performed to form the straight portion such as the shaft hole and the shaft coupling portion.

And based on the transfer direction of the strip material, at the last stage of the progressive die, that is, the blanking stage, the blanking process is performed simultaneously with the shift processing step. Accordingly, the laminated core manufactured by the above-described method may have both the straight portion 11 and the skewed portion 12.

Although the preferred embodiments of the present invention have been disclosed for illustrative purposes, it should be understood by those skilled in the art that these embodiments are given by way of illustration only and the present invention is not limited thereto.

Therefore, various modifications, variations, and alterations can be made by those skilled in the art without departing from the spirit and scope of the present invention. And the scope of the invention should be limited only by the accompanying claims and equivalents thereof.

### INDUSTRIAL APPLICABILITY

The present invention can be used for manufacturing the laminated core having a straight portion that is stacked in a straight line parallel to the axis of the laminated core and a skewed portion laminated in a skewed shape, by a progressive die.

What is claimed is:

1. A laminated core manufacturing apparatus comprising:
a blanking unit for sequentially forming laminas by blanking strip material which is intermittently transferred for a manufacturing laminated core;
a first processing unit provided at a first side of the blanking unit, for processing the strip material before blanking the strip material, the first processing unit being intermittently rotatable by a predetermined angle for changing the processing position by rotational movement and processing the strip material;
a second processing unit provided at a first side or a second side of the first processing unit and processing the strip material at a predetermined position; and
a lamination die provided coaxially with the blanking unit and having a lamination space of the laminas sequentially formed by blanking of the strip material.

2. The laminated core manufacturing apparatus of claim 1,
wherein first processing unit includes:
a first die which is rotatable intermittently by a predetermined angle around the rotation axis of the first processing unit; and
a first tool facing the first die, configured to move forward and backward for processing the strip material, and rotatable at the same angle simultaneously with the first die.

3. The laminated core manufacturing apparatus of claim 2,
wherein the blanking unit includes a blanking punch provided at an upper die capable of reciprocating in a direction perpendicular to the strip material, and a blanking die facing the blanking punch and provided at a lower die facing the upper die;
and wherein the first tool moves toward the first die by the upper die to process the strip material.

4. The laminated core manufacturing apparatus of claim 3, wherein the first tool is configured to be pressed by the upper die so as to move toward the first die, and is supported by an elastic member restoring the first tool; and wherein the first processing unit further includes a connector for integral rotation of the first die and the first tool.

5. The laminated core manufacturing apparatus of claim 4, wherein the first die is provided on a rotatable die support; and wherein the die support is connected to a driving device transmitting rotation power to the die support.

6. The laminated core manufacturing apparatus of claim 3, wherein the first tool is provided at a tool holder; wherein the tool holder includes a tool shaft forming an axis of the first tool; and wherein the tool shaft is rotatably inserted in a shaft hole formed at the upper die.

7. The laminated core manufacturing apparatus of any one of claims 2 to 6,
wherein the first tool includes a slot punch for punching the strip material at predetermined timings to form a slot of the laminated core.

8. A laminated core manufacturing method of a progressive type manufacturing a laminated core by blanking a strip material at predetermined timing for manufacturing the laminated core, the strip material being intermittently transferred, comprising:
processing sequentially target areas of blanking at a predetermined interval along a transfer direction of the strip material and changing a processing position at a predetermined angle each time the strip material is processed.
